(19) United States
(12) Patent Application Publication
(10) Pub. No.: US 2024/0193525 A1
(43) Pub. Date: Jun. 13, 2024

(54) AUTOMATED COSTING OF INTERMEDIATE PRODUCTS OF A CRUDE DISTILLATION UNIT IN A REFINERY

(71) Applicant: Saudi Arabian Oil Company, Dhahran (SA)

(72) Inventors: Khalid M. Zahrani, Dammam (SA); Yousif Fuod Abualsoud, Qatif (SA); Hashim M. Hajji, Al Twaitheer (SA)

(21) Appl. No.: 18/535,720

(22) Filed: Dec. 11, 2023

Related U.S. Application Data
(60) Provisional application No. 63/431,961, filed on Dec. 12, 2022.

(51) Int. Cl. G06Q 10/0639; G06Q 10/20; G06Q 30/0283

(52) U.S. Cl. CPC G06Q 10/06393; G06Q 10/20; G06Q 30/0283; G06Q 50/06

(57) ABSTRACT

Systems and methods include a computer-implemented method for intermediate crude oil distillation product estimates. Field data for distillation column feed streams and associated processes of a crude distillation unit of an oil refinery are received. Maintenance history events and estimates per event of each distillation column are received. Mass and energy balance around each distillation column are performed. Reconciled data and thermodynamic properties for each distillation column are determined. Key performance indicators (KPIs) for each distillation column are determined. A decision support model modeling activity-based information for the oil refinery is executed using the KPIs. Information regarding operation of the oil refinery at a current performance level is determined. Proactive and reactive data for distillation column estimate performance of each of the distillation columns are determined. The proactive/reactive data and KPIs for distillation column estimate performance of the distillation columns are provided for display in a user interface.

### CROSS-REFERENCE TO RELATED APPLICATIONS

This application claims the benefit of U.S. Provisional Application Ser. No. 63/431,961 filed on Dec. 12, 2022, the entire contents of which are incorporated by reference in its entirety.

### TECHNICAL FIELD

The present disclosure applies to operations at refineries.

### BACKGROUND

Most oil and gas operating facilities use a set of scattered, discipline-specific applications that support their daily activities. The applications may have different levels of automation that vary from one facility to another. Methodologies are not currently known to exist for automated, computer-implemented estimation (e.g., costing) of intermediate products, specifically crude distillation products, e.g., where a planning team may identify whether the process of crude unit cost is more economical than other distillation units. Current methodologies may rely on disjoint processes, for example, in which the various computer systems and associated data are not integrated. The data within these applications are typically accessed by domain-specialized people with minimal collaboration and interaction with other end users within the same operating facility. This arrangement can result in: 1) users spending a significant amount of time (up to 50%) trying to fetch the data from data sources; 2) the creation of different versions of truth with variance in the level of data quality (raw data vs. validated and reconciled data) due to the scattered data sources; 3) a slow decision-making process that is more reactive and after the fact than proactive; 4) the condition for specialized training (for each discipline) to make use of the discipline-specific data; 5) the creation of different processes and practices within the same organization in each unit; and 6) the generation of rigid and static reports.

### SUMMARY

The present disclosure describes techniques that can be used for estimating values of intermediate products of the crude distillation unit in a refinery. In some implementations, a computer-implemented method includes the following. Field data for distillation column feed streams and associated processes of a crude distillation unit of an oil refinery are received. Maintenance history events and estimates (costs and resource values) per event of each distillation column of the oil refinery are received. Mass and energy balance around each distillation column is performed using the field data. Reconciled data and thermodynamic properties for each distillation column are determined using the mass and energy balance around each distillation column. Key performance indicators (KPIs) for each distillation column are determined using the reconciled data and thermodynamic properties for each distillation column and the maintenance history events and estimates per event. A decision support model for the oil refinery is executed using the distillation column performance KPIs. The decision support model models activity-based information. Information regarding operation of the oil refinery at a current performance level is determined based on executing the decision support model. Proactive and reactive data and KPIs for distillation column estimates performance of each of the distillation columns are determined based at least on the information regarding operation of the oil refinery. The proactive and reactive data and KPIs for distillation column estimates performance of each of the distillation columns are provided for display in a user interface.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. A facility's profit margin can be maximized and its cost estimate minimized by allocating resources properly and efficiently. This can provide advantages over systems that are distributed through separated function-specific applications with each application providing its own data. Such distributed systems create several challenges in terms of managing the manufacturing operation. For instance, the systems provide large amounts of not-yet-validated data that is prone to error and require designated subject matter experts (SMEs) per application to rationalize the data into usable information. As a result, the derived knowledge from the information is not only reactive and delayed, causing what is referred to as “different versions of the truth,” which in turn hinders the decision support process.

Techniques of the present disclosure can break silos between the different disjoint automated systems by providing a methodology to make an integrated hub (or system) to timely integrate information and to facilitate automatization of industrial plant operation adjustments. The integrated system can collect the distillation column's field data and its maintenance history, cleanse the data, reconcile the data utilizing thermodynamics packages, generate key performance indicators (KPIs), compare actual versus target versus planned values, and convert the data to estimates (e.g., process efficiency, econometric values, or other performance metrics) that can be compared to set thresholds to trigger automatic implementation of system operation adjustment. As an example, the distillation column integrated solution can provide an activity-based costing financial model capitalizing on one system instead of disjoint siloed systems. Current systems in this space do not cover the interfaces with other input systems to fully close the business process. Current systems do not solve the problem of data cleansing prior to allocating costs. Current systems do not provide techniques for allocating the cost of maintenance activities over a yield percentage. The techniques of the present disclosure can solve the activity-based costing in the oil and gas industry that is not available in the current systems. This can solve the problem of identifying a systematic approach to allocate the cost of maintenance and human resources (HR) over each product. There is no available commercial off-the-shelf (COTS) product that can provide all of these functionalities within a single system. Hence, the integration between multiple products is required to meet the objective of the invention.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1A is a diagram of a network that shows how the different systems are distributed across an operating facility, according to some implementations of the present disclosure.

FIG. 1B is a diagram showing an example of a crude distillation unit, according to some implementations of the present disclosure.

FIG. 2 is a diagram showing an example of a computer system for allocating activity estimates, according to some implementations of the present disclosure.

FIG. 3 is a diagram showing an example of a system for providing processes and data exchange between the different systems.

FIG. 4 is a flowchart of an example of a method for estimates of intermediate products of the crude distillation unit in a refinery, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for monitoring and providing an activity-based value model of a crude distillation column in refinery processing, and providing quality control by estimating the quality of the intermediate streams to meet minimum operational standards, such as air emission consequences throughout the increase in the energy load. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure include an automated system to estimate a value of the intermediate streams of a refinery that is downstream of a crude distillation unit. The system can bridge the automation gap and maximize the utilization of existing applications in plants through a seamless integration into a single system. The system can automatically and continuously collect raw data from multiple sources of an industrial system, validate the data to ensure that data quality is within an appropriate level of confidence, and provide result data based on the processed collected data for adjusting a configuration of the industrial system.

The system can determine relationships between feed inbound data retrieved from different sources, e.g., data historian, distributed control system (DCS), and enterprise resource planning (ERP). Based on relationships that exist in the inbound data between the mass yield of the column products, the system can provide: the relationship of the feed entry data within the system that includes 1: feed crude type, feed crude mass quantity, feed price, and product shadow cost; 2) utility cost and utility quantity; 3) human resources (HR) costs; and 4) maintenance costs. The computer system includes a model configured to apply a frequency pattern, which normalizes and identifies associations between the inbound data during predefined periods of time. The system allocates the input parameters to a column product value based on a normalized mass yield of each product. The computer system provides for display, on a graphical user interface, trends of product values.

Techniques of the present disclosure can be used to create an integrated solution implementing an activity-based model of the crude column, providing a hybrid and integrated digitized solution for automatically, securely, and accurately tracking proactive and predictive KPIs in real time and adjusting a system configuration based on one or more of the determined KPIs. The term real-time can correspond, for example, to events that occur within a specified period of time, such as within one minute. The system can also correlate the performance with the refinery orders compliance and gross margin by identifying planning targets and tracking production costs per product using allocation techniques for cost of feed, utilities, and fixed costs.

The techniques can be implemented with an architecture of integrated computer-based systems that evaluate intermediate products from refining process units by including charges associated to process efficiency or other performance metrics including costs of potential malfunctions, the utilities costs, HR costs, and maintenance costs. This can result in accurately determining the value and charges of intermediate products within the refinery. As a result, a decision support system can be provided that enhances an efficiency of an industrial process of refineries and their operation.

The computer-based system can include predictive capabilities for the KPIs in order to further improve the decision-making process for adjusting industrial system operations. The predictive capabilities can facilitate an automatic preparation of resources for a predicted scenario and address the scenario accordingly with minimized losses.

The techniques can be implemented at a crude distillation process unit, which can be a main unit of a crude oil refinery connected to multiple intermediate products. The automatic real time analysis of a crude distillation unit's intermediate products can provide a flexibility in adjusting an operation for the unit, that can prevent disruption of an industrial system, for example when downstream units are not available to process the intermediate products.

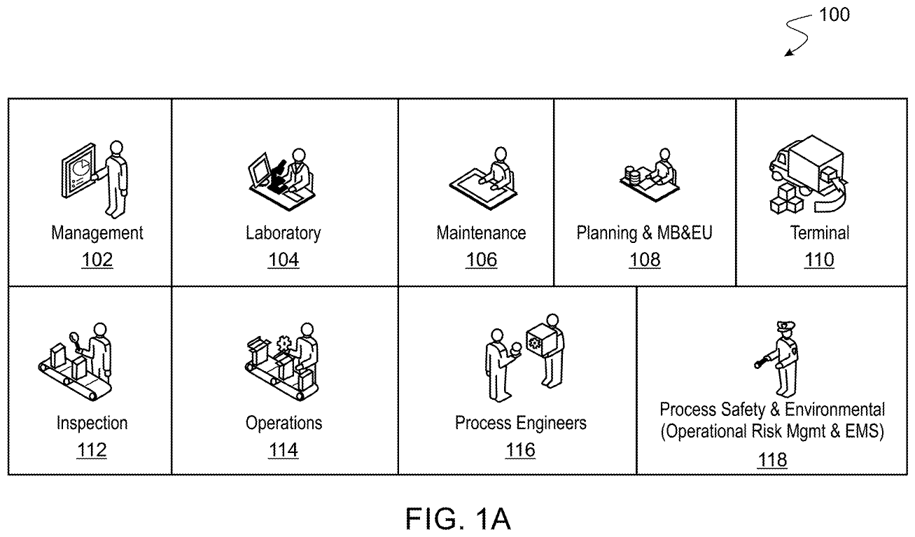

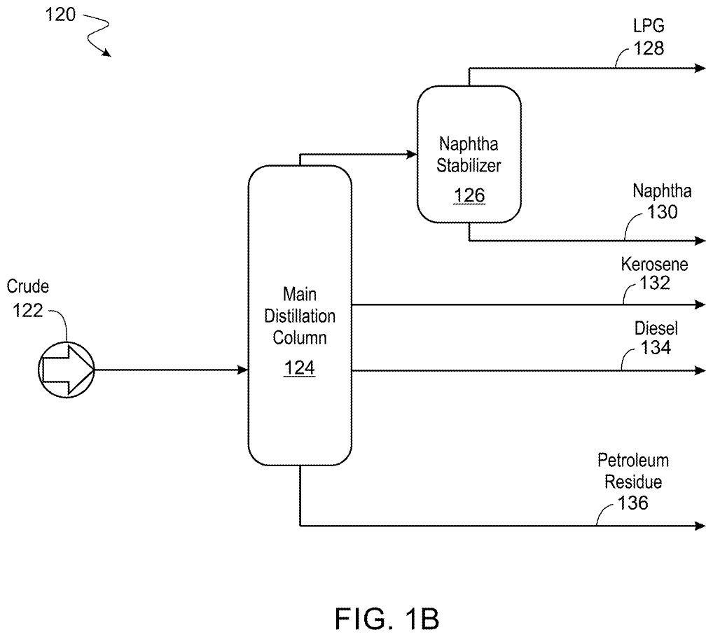

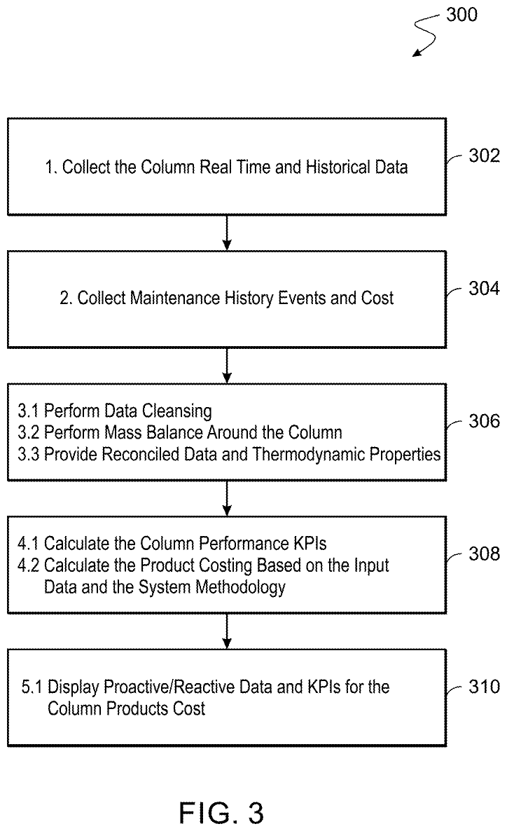

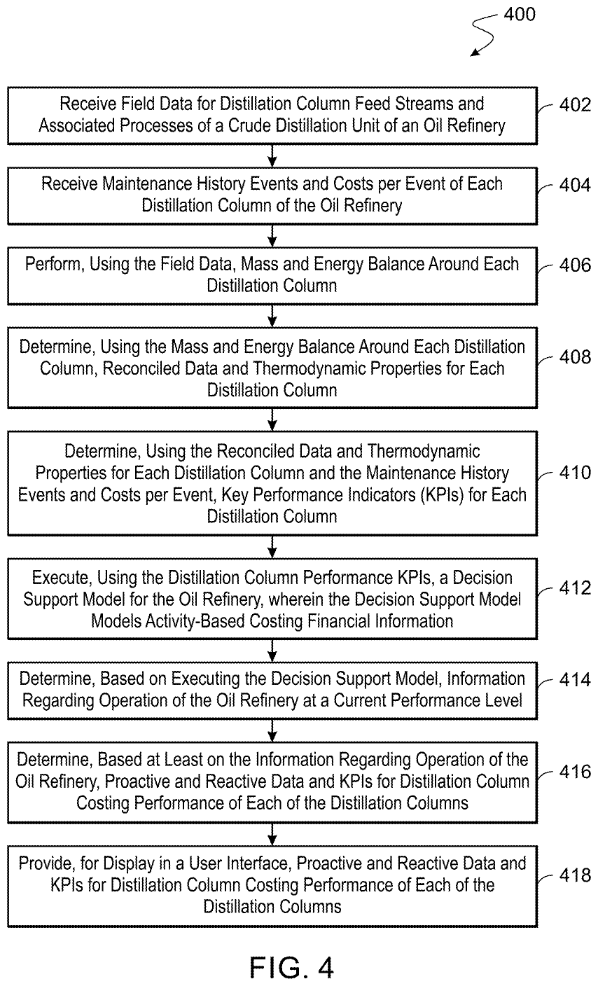

FIG. 1A is a diagram of an example industrial system 100 that shows how the different systems are distributed across an operating facility, according to some implementations of the present disclosure. The example industrial system 100 also includes a management system 102, a laboratory information management system 104, a reliability and maintenance system 106, a planning system, the manufacturing system, and economics unit (EU) system 108. The example industrial system 100 also includes terminals 110, an inspection team system 112, operation system 114, a process engineers system 116, and process safety and environmental operational risk management (EMS) system 118. One or more of the systems 102-118 can be a server system or a computing device that can execute the process described with reference to FIGS. 3 and 4.

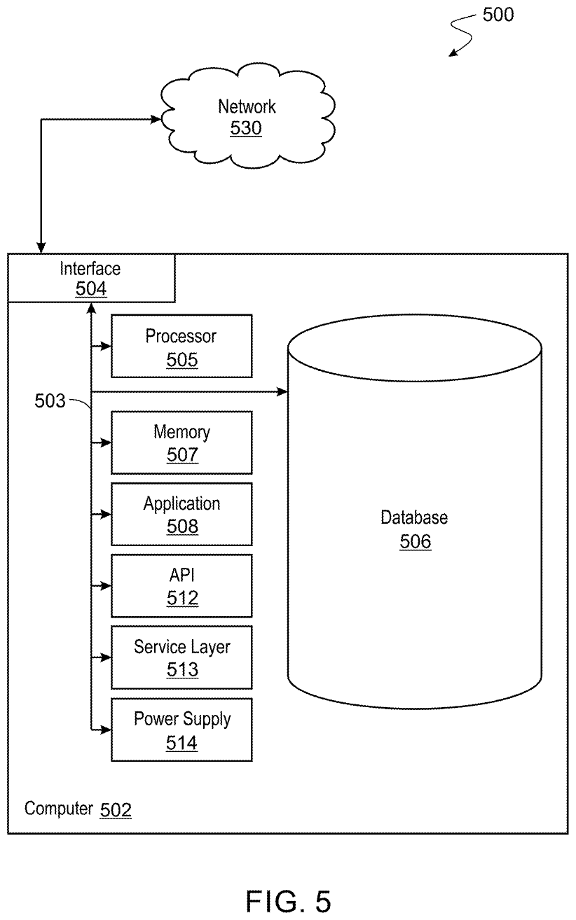

The server system is intended to represent various forms of servers including, but not limited to a web server, an application server, a proxy server, a network server, and/or a server pool. In general, server systems accept requests for application services and provides such services to any number of computing devices (e.g., the computing device over a network, as described with reference to FIG. 5). In accordance with implementations of the present disclosure, and as noted above, the server system can host a solution environment that can be a cloud environment providing software applications, systems, and services that can be consumed by the systems 102-118 as a service. In some instances, the server system can support a hybrid and integrated digitized solution for tracking of proactive and predictive KPIs in real time and configuring various systems 102-118 of the example industrial system 100 for adjusting an operation of the example industrial system 100. The server system includes a processor, a memory, and an interface.

The computing device can be any computing device operable to connect to or communicate in the network(s) using a wireline or wireless connection. In general, the computing device includes an electronic computer device operable to receive, transmit, process, and store any appropriate data associated with the system 100 of FIG. 1A. The computing device is generally intended to encompass any client computing device such as a laptop/notebook computer, wireless data port, smart phone, personal data assistant (PDA), tablet computing device, one or more processors within these devices, or any other suitable processing device. The computing device includes interface(s), processor(s), memory, and graphical user interface. The computing device can include one or more applications. The application can be any type of application that allows a client device to request and view content on the client device. In some implementations, a client application can use parameters, metadata, and other API and event dependency information received at launch to a communicatively coupled system and/or the server system. In some instances, a client application that supports a hybrid and integrated digitized solution for tracking of proactive and predictive KPIs in real time and configuring various systems 102-118 of the example industrial system 100 for adjusting an operation of the example industrial system 100. For example, the computing device can include a computer that includes an input device, such as a keypad, touch screen, or other device that can accept user information, and an output device that conveys information associated with the operation of the server system, or the client device itself, including digital data, visual information, or a graphical user interface (GUI), respectively.

The GUI can interface with at least a portion of the system 100 for any suitable purpose, including generating a visual representation of the client application 126 or the application 126, respectively. In particular, the GUI can be used to view and navigate various Web pages. Generally, the GUI provides the user with an efficient and user-friendly presentation of data provided by or communicated within the system 100. The GUI can include multiple customizable frames or views having interactive fields, pull-down lists, and buttons operated by the user. The GUI can include any suitable graphical user interface, such as a combination of a generic web browser, intelligent engine, and command line interface (CLI) that processes information and efficiently presents the results to the user visually.

Each system in the example industrial system 100 produces its own data. For example, management system 102 relies on the ERP system that produces data for the management system 102. The laboratory information management system 104 produces data that is handled by a laboratory of the facility. The planning system, the manufacturing system, and economics unit (EU) 108 system are generating linear programming (optimization) models based on data derived from particular software before communicating the data to computing system of process engineers. In some implementations, for example, for security reasons, the data generated by one of the systems is not directly shared (transmitted) to all systems of the on a real-time basis. In some implementations, unless a distillation column performance degrades, the system of the process engineers 116 does not transmit collected and/or processed information to the system of the reliability and maintenance 106 team. In case of a reactive scenario, the manufacturing, planning and economics unit personnel may react to the situation by adjusting an operation of the industrial system 100, such as the plan and schedule of manufacturing. The reactive adjustment can lead to a response delay, and in turn, can trigger additional disadvantages.

### Introduction to Crude Distillation Unit Operation

FIG. 1B is a diagram showing an example of an operation of the example industrial system 100, described with reference to FIG. 1A. The example operation includes a crude oil distillation process that can be executed, at least in part, by a crude distillation unit 120, according to some implementations of the present disclosure. The crude oil distillation process is a core component of crude oil refining and is the largest unit in terms of product capacity that is processed.

The distillation process is meant to separate different fractions from the crude oil based on their physical properties, e.g., based on boiling point. When crude oil is transferred to the crude oil distillation unit, the crude oil is treated in order to protect the downstream assets, such as heat exchangers and distillation columns, from corrosion. In other words, the salts that are present in the crude oil have to be minimized to low levels so that the salt does not form an acidic content that jeopardizes the metal integrity of assets. The treatment of the crude oil happens in stages of desalting, where the crude oil is washed and desalted before it gets heated. The desalted crude gets heated to boiling temperatures in order to achieve the separation of the different cuts in the distillation column, at which time the vapors generated from the crude are in direct contact with the down-flowing liquid. The vapor to down-flowing liquid contact results in achieving boiling point equilibrium stages for the different fractions. Each fraction is captured on collection trays that are equipped with drawing nozzles that send the product out of the column for further treatments or storage. The products produced from the crude atmospheric distillation unit include liquefied petroleum gas (LPG) 128, naphtha 130 (produced by a naphtha stabilizer (126), kerosene 132, diesel 134, and petroleum residue 136 produced by a main distillation column 124 from crude 122.

There are several physical assets (e.g., process equipment) that are included in a crude distillation unit in order to achieve the separation process and to produce the aforementioned fractions. The assets can vary from heat inducers, pressure changers, de-salters, and collection drums, in addition to the normal manufacturing plant auxiliaries.

For the heat inducers, being the main energy driver, the crude distillation unit is furnished with trains of heat exchangers that are configured to be parallel or in series with the main purpose of transferring heat to the fresh crude oil from the hot streams branching from the distillation process. Usually, the pre-heat trains increase the temperature of the crude oil from ambient temperature to temperatures as high as 300 degree Celsius, depending on the type of the crude and the design of the distillation process. In between the heat exchanger trains, de-salters can be used to reduce the salt and water content in the crude oil to low limits to minimize its integrity impact downstream. Another heat inducers include fired heaters (e.g., furnaces) which are in the heart of the distillation process. A fired heater sits in a position directly upstream of the distillation column and is responsible for providing the last increment in temperature to meet the distillation column conditions. The fired heater typically consists of three main compartments that are equipped with particular components to achieve the planned job. The first compartment is the radiation box, where a pilot burner is used to light burners with specially-designed fuel nozzles that are attached to an air source. This creates a combustion that is the source of the heat that gets transferred to several tube passes, carrying crude oil by radiation heat. On top of the radiation box sits a convection section which includes a continuation of the tube passes that are heated by convective heat transfer. And, finally, the stack of the fired heater sends the flue gasses to the atmosphere after its heat content is used in the tube passes. While the fired heaters job sounds simple, it requires a great deal of control and measurement of the combustion parameters as well as the pressure inside the radiation box.

For the pressure changers, pumps with different sizing are used to transfer product to other refining units for either further treatments or storage. Also, some crude distillation units employ compressors to recover some of the off gasses from the distillation column for environmental and reasons.

Finally, the collection drums are used as a mechanism for buffering product transfers in order to control the production movements internally without impacting either the load on the distillation column nor the pumps that ship the product downstream.

### System and Method Description

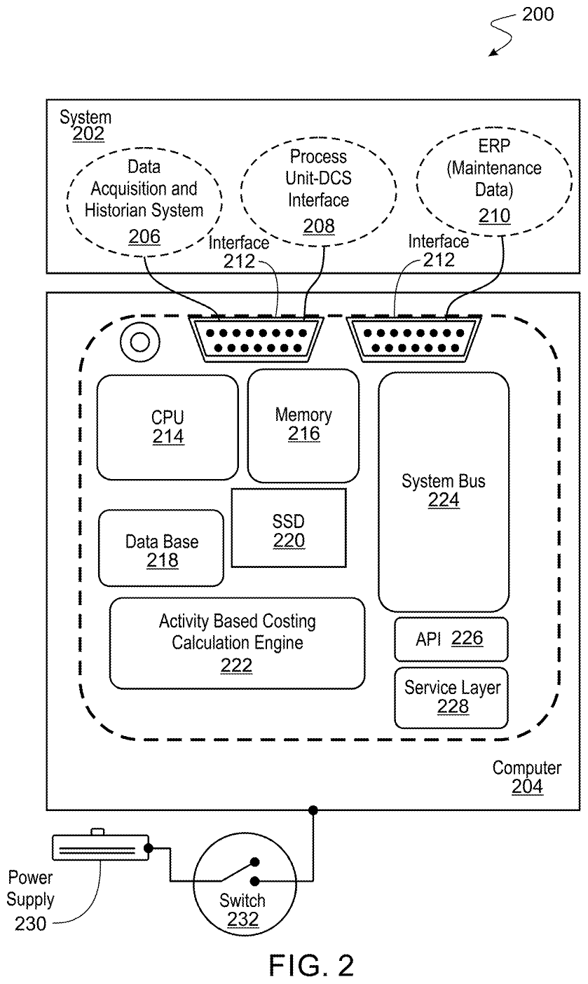

FIG. 2 is a diagram showing an example of a computer system 200 for allocating activity costs, according to some implementations of the present disclosure. Allocation can include, for example, determining a relationship between the feed inbound data retrieved from different sources (data historian, DCS, ERP) based on the relationship between the inbound data between the mass yield of the column products. The computer system 200 provides the relationship of the feed entry data within the system that includes 1: feed crude type, feed crude mass quantity, feed price, and product shadow cost (e.g., a value estimate assigned to an item, system, or a process that is not sold in any marketplace); 2) utility cost and utility quantity; 3) human resources (HR) costs; and 4) maintenance costs.

In some implementations, the computer system 200 includes a network 202 and a computer 204. The network 202 includes a data acquisition and historian system 206, a process unit DCS interface 208, and enterprise resource planning (ERP) maintenance data 210. The computer 204 includes an interface 212 with the network 202. The computer 204 includes a central processing unit (CPU) 214, memory 216, at least one database 218, at least one solid state drive (SSD) 220, an activity-based calculation engine 222, a system bus 224, at least one application programming interface (API) 226, and a service layer 228. The computer 204 can be powered by a power supply 230 that can be controlled by a switch 232.

The computer system employs a frequent pattern, which normalizes and identifies associations between all inbound data at a defined period. The system allocates all input parameters to the column product shadow cost based on the normalized mass yield of each product. The computer system can provide a graphical view (e.g., a user interface (U/I) which tracks the product cost result into one graphical view.

In response to determining that the data is retrieved by the computer system, the impact on KPIs are generated in real-time using an activity based (ABC) model of the column performance that is hybrid and integrated. The system also correlates the performance with the refinery orders' compliance by identification of planning targets and tracking of production estimate per product using allocation techniques for the estimate of feed, utilities and fixed estimates.

Estimates (e.g., process efficiency parameters or cost) can be assigned to each operational activity of the column. The calculation enables the determination of estimate per operation action and performs analysis among different scenarios. This is accomplished by knowing the rules that allow for identifying and tracking variable and fixed estimates per process.

For example, using this methodology can allow refineries to run their assets to maximize profit and/or margin by increasing sales revenues and decreasing operating estimates by making timely, reliable, and accurate decision-making. This allows refineries to: 1) select the best operation mode to produce the products with the least estimate; 2) track the estimate of orders; 3) avoid production loss; and 4) identify actions that contributed to reducing revenues or increasing estimate.

The techniques of the present disclosure provide an intelligent, hybrid and integrated solution for distillation column products estimates. This provides comprehensive and unique system evaluation solutions, economic operation solutions and associated digitalized information, operation, and engineering technologies with scientific execution methodology that facilitate monitoring the end-to-end process of overall operation with a focus on the following two identification functions.

First, the techniques can be used to identify the distillation column activity-based costing design and execution methodology and associated documentation and diagrams needed to achieve the economic operation. Techniques include developing an integrated business process modeling of distillation column activity-based costing with functional decomposition and sequential execution and workflow. Techniques include developing the integrated solution architecture of the required software platform technologies utilized to collect data, generate KPIs, perform analysis, visualize results to track the econometrics KPIs, and perform the production costing to perform the analysis for the causes of violations of cost and revenues. Techniques include developing the cost, revenue, economic and financed data flow model with naming conventions and an integration matrix of data attributes among the different source and destination software platform technologies. Techniques include developing a service-based integration model with message routing and associated situation management to pass estimate and activity messages among different source and destination software platform technologies. Techniques include developing a user-based information model with economic and estimate-based tasks, data, execution sequencing, software platform technologies and associated five-dimension swim lane diagrams.

First, the techniques can be used to identify the following monitoring and tracking of distillation column activity-based estimates and the associated operation functions as well as the associated integration of data, KPIs, and events. Digital tracking is performed on proactive and predictive KPIs at real-time and semi real-time resolution for: 1) production rates of most valuable parameters and associated prices, 2) flow rates of utilities (e.g., fuel, steam), and 3) production estimates. Planning targets for estimates and margin and associated intermediate price are identified. Role-based KPIs drill-down trees from and dashboards are visualized.

### Systems Details

This present disclosure provides a methodological solution for generating an activity-based model of distillation column operation performance. Generating the model can be accomplished by linking the impact at different organization levels using the integration of different systems to perform the analysis efficiently and systematically through one collaborative work environment among all different stakeholders. These systems are tabulated in Table 1:

TABLE 1
Systems and Modules

| | | |
|---|---|---|
| System | Abbreviation | Description |

Data Sourced Systems:

| | | |
|---|---|---|
| Data Acquisition and | DAHS | Data warehouse system that receives real-time |
| Historization System | | and historical time-stamped plant data from a |
| | | variety of sources. |
| Enterprise Resource | ERP | System to manage an organization day-to-day |
| Planning System | | processes (e.g., maintenance and accounting) |

The innovated system modules

| | | |
|---|---|---|
| Data Validation and | DVR | Technology that optimizes problems under |
| Reconciliation | | constraints. The technology uses a plant's |
| | | measurement data and associated accuracy to |
| | | provide a consistent set of material balanced |
| | | operating data. For example, optimizing |
| | | problems can refer to producing a threshold |
| | | percentage of valid and consistent values |
| | | greater than a predefined threshold. |
| Key Performance | KPIM | Mathematical calculation engine to perform |
| Indicators Management | | thermodynamic and non-thermos dynamic |
| System | | calculations. |
| Integration System | — | Technology that integrates the individual |
| | | systems together to enable data exchange |
| | | between these systems. |
| Decision Support and | DSV | Real-time visualization access to performance |
| Visualization System | | information including performance data |
| | | acquisition, aggregation, transformation and |
| | | presentation |

### Methodology Work Processes

The methodology is executed based on integrated processes modeling of the distillation column and the associated process. The described processes depend on the architecture of the software hosting the different types of data and, therefore, requires development of integrated solution architecture to perform the analysis. For the described disclosure, the processes and data exchange between different systems are illustrated below,

FIG. 3 is a diagram showing an example of a process 300, according to some implementations of the present disclosure. The example process 300 can be executed by any component of the system 100 and/or system 500, described with reference to FIGS. 1 and 5.

At 302, field data is obtained, by one or more processors and from sensors monitoring one or more parameters of an industrial plant (system). The sensors can be attached to feed streams and can be configured to collect data reflecting operational parameters of associated processes (e.g., fuel gas properties and parameters, process feed parameters, and air intake parameters.) The field data can be passively obtained or actively retrieved by generating triggering signals for data collections that are transmitted via a network coupling the one or more processors to the sensors. The sensors can be configured to automatically transmit in real time via the network any and all collected data. In some implementations, the field data can be tagged to facilitate data serialization (for optimization of data processing) and data identification.

At 304, each column's maintenance history events and estimate per event are obtained by actively retrieving from a database configured to store maintenance history events. The column's maintenance history events can be obtained by actively retrieving (monitoring) and/or receiving column's maintenance history events extracted over a time period from a database associated to a particular address of a memory, e.g., random access memory (RAM) such as a memory cache or other RAM, of the computing device.

At 306, the field data and column's maintenance history events are processed to generate data cleansing, to determine mass and energy balance around the distillation column, to identify reconciled data and to determine thermodynamic properties. Data cleansing includes detection of outlier (wrong) data and correction of the outlier data, by deleting the outlier data and replacing it with either last good value or the averaged number of last specific time. The data reconciliation uses statistical analysis of the system to correct measurement errors that are due to measurement noise, such as random errors. The statistical analysis applied to reconcile data is selected based on expected data distribution types to align the measured data to the expected distribution type for deriving and implementing an optimal estimation solution of error free data sets.

At 308, the distillation column performance KPIs are determined, by using a decision support model, such as the energy consumption per unit mass of feed. A decision support model can be performed to support whether to continue operating at the performance. The decision support model generate reactive/proactive data and KPIs for the column estimate performance. The reactive data and KPIs for the column estimate performance can be determined using derivation formulas that combine collected data (treated as a complete set of known parameters). The proactive data and KPIs for the column estimate performance can be determined using a trainable predictive model configured to process collected data (treated as an incomplete set of parameters) in combination with trainable scenarios to generate accurate proactive data and KPIs for the column estimate performance. The trainable predictive model can include a machine learning model trained to In some example embodiments, the machine learning model can be subjected to supervised pre-training, for example, to generate proactive/reactive data and KPIs for the column estimate performance and, a coupled machine learning model is fine-tuned to generate a control signal for industrial plant operation adjustment to prevent a malfunction, risky (potentially leading to damages) or inefficient operations. The machine learning model configured to trigger operations of a system controller can be collaboratively trained with the machine learning model that generate proactive/reactive data and KPIs for the column estimate performance by adjusting one or more weights applied by the first machine learning model generating one or more questions in order to minimize an error in an output of the second linked machine learning model. In some example embodiments, the pre-trained machine learning models can be fine-tuned to facilitate continuous adaptation of the machine learning models to changing parameters and scenarios of industrial system operations.

At 310, proactive/reactive data and KPIs for the column estimate performance can be displayed, e.g., in a user interface. Alerts and advisories can be displayed in the GUI of one or more systems. The alerts can include an indication that an automatic adjustment of a system operation is imminent to prevent a malfunction that can be described at a level of detail matching a system type providing the alert for display. The operation adjustment can include transmission of control signals from the one or more processors to components of the industrial plant to at least partially modify (close or open valves, activate or deactivate switches), direct, and/or normalize flows, to maintain safe operation of the industrial plant. A distillation column activity-based methodology can include the two major features.

An advantage of the processes described in the present disclosure is that they provide access to proactive/reactive data and KPIs for the column estimate costing performance in real time, in a secure, and transparent way, using an access configuration that can be extended or restricted depending on a model privacy policy. Configurations can define a ranking for system operation adjustments, which provide values and ranges that are usable to select between system adjustment scenarios and are accessible by the machine-learning models, which allows to define different models for the same domain, the different models corresponding to different target industrial plants (e.g., regions). The access configurations can be pre-defined by users (e.g., system administrators), and are changeable by the users of the application, without modifications to application code. An analysis and execution of the distillation activity-based estimates can include the following features. Performing variance analysis can be conducted between planned, targets and actual estimates. The allocation process can be identified based on hybrid techniques extracted from the product yields from the feedstock. analytics can be performed to display process estimates, and outcome data.

Identifying integration activity-based estimates and the associated operation excellence (EOE) conditions can include the following features.

Archiving of production data and KPI generation functions and systems can be integrated with functions and systems to collect flow and data (e.g., system efficiency parameters, costs, and prices) to calculate estimates of utilities and process outcome (e.g., system operational success and/or revenues of sales). Archiving of production data functions and systems can be integrated with KPI generation functions and systems to calculate production estimate allocation and total production estimate per product. Archiving of production data functions and systems and asset reliability production analytics functions and systems can be integrated to calculate production loss resulting from mechanical failure. Archiving of production data functions and systems and maintenance work order functions and systems to calculate the estimate of the order and associated order to an asset (e.g., financial instrument). Planning model functions and systems can be integrated, and production data functions and systems can be archived to calculate variance and to calculate the allocation of the production estimates.

Visualization of intelligence functions and systems can be integrated with all other functions and systems to display role-based KPIs using drill-down, such as the finance and economic dashboard. For example, planned or subsequent activity-based costing (ABC) and the associated economic operation compliance with financial planning and order targets can be ensured. The activity-based costing and the associated economic operation digitization technologies can be identified, provided and configured: 1) real-time and transactional monitoring technologies to proactively and reactively track the flow of products and utilities; 2) production, integrity, and reliability repository technologies to generate production data and economic KPIs and events; 3) simulation and modeling; 4) advanced analytics technologies to correlate and identify activities that resulted in estimate (e.g., system efficiency and cost) and revenue violations; 5) visualization technologies (including intelligence software with on-line analytical processing, and intelligent integrity operating windows software; 6) integration technologies; and 7) enterprise/application service bus based on service oriented architecture.

FIG. 4 is a flowchart of an example of a method 400 for estimates intermediate products of the crude distillation unit in a refinery, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

At 402, field data for distillation column feed streams and associated processes of a crude distillation unit of an oil refinery are received. For example, field data can be received from a crude distillation unit 120 or systems interacting with the crude distillation unit 120. The field data can include fuel gas properties and parameters, process feed parameters, and air intake parameters, for example. From 402, method 400 proceeds to 404.

At 404, maintenance history events and estimates per event of each distillation column of the oil refinery are received. The events can include events, steps, and components described with reference to the 1B. From 404, method 400 proceeds to 406.

At 406, mass and energy balance around each distillation column are performed using the field data. For example, the mass and energy balance can be performed on the main distillation column 124. From 406, method 400 proceeds to 408.

At 408, reconciled data and thermodynamic properties for each distillation column are determined using the mass and energy balance around each distillation column. For example, the mass and energy balance can be performed on the main distillation column 124. From 408, method 400 proceeds to 410.

At 410, key performance indicators (KPIs) for each distillation column are determined using the reconciled data and thermodynamic properties for each distillation column and the maintenance history events and estimates per event. The performance KPIs can include, for example, an energy consumption per unit mass of feed though the distillation column. From 410, method 400 proceeds to 412.

At 412, a decision support model for the oil refinery is executed using the distillation column performance KPIs. The decision support model models can be based on activity-based information. From 412, method 400 proceeds to 414.

At 414, information regarding operation of the oil refinery at a current performance level is determined based on executing the decision support model. The information can appear, for example, on consoles or in user interfaces of computer systems at refineries or at local or remote systems interfacing with the refineries. From 414, method 400 proceeds to 416.

At 416, proactive and reactive data and KPIs for distillation column estimates performance of each of the distillation columns are determined based at least on the information regarding operation of the oil refinery. For example, the proactive and reactive data can include suggestions for actions to performed at the oil refinery. From 416, method 400 proceeds to 418.

At 418, the proactive and reactive data and KPIs for distillation column estimate performance of each of the distillation columns are provided for display in a user interface. After 418, method 400 can stop.

In some implementations, method 400 further includes decision-making steps. For example, a decision (or suggestion) can be generated whether to continue operating the oil refinery at the current performance level. Information about the decision can be provided for display in the user interface. Based on the displayed information, the user can select an option that is automatically applied by the system, for example, to change operations at the oil refinery.

In some implementations, method 400 further includes generating, based on the information regarding operation of the oil refinery, alerts and advisories for display in the user interface. The alerts and advisories can be implemented, for example, as one or more of text message, email messages, phone calls, or messages that appear on consoles or in user interfaces of computer systems at refineries or at local or remote systems interfacing with the refineries.

In some implementations, in addition to (or in combination with) any previously described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, estimates, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to the settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or a combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a computer-implemented method includes the following. Field data for distillation column feed streams and associated processes of a crude distillation unit of an oil refinery are received. Maintenance history events and estimates per event of each distillation column of the oil refinery are received. Mass and energy balance around each distillation column are performed using the field data. Reconciled data and thermodynamic properties for each distillation column are determined using the mass and energy balance around each distillation column. Key performance indicators (KPIs) for each distillation column are determined using the reconciled data and thermodynamic properties for each distillation column and the maintenance history events and estimates per event. A decision support model for the oil refinery is executed using the distillation column performance KPIs. The decision support model models activity-based information. Information regarding operation of the oil refinery at a current performance level is determined based on executing the decision support model. Proactive and reactive data and KPIs for distillation column estimates performance of each of the distillation columns are determined based at least on the information regarding operation of the oil refinery. The proactive and reactive data and KPIs for distillation column estimates performance of each of the distillation columns are provided for display in a user interface.

The foregoing and other described implementations can each, optionally, include one or more of the following features:

A first feature, combinable with any of the following features, where the field data includes fuel gas properties and parameters, process feed parameters, and air intake parameters.

A second feature, combinable with any of the previous or following features, where the KPIs include an energy consumption per unit mass of feed though the distillation column.

A third feature, combinable with any of the previous or following features, where the method further includes performing data cleansing on the received field data and the maintenance history events and estimates per event.

A fourth feature, combinable with any of the previous or following features, where the method further includes generating a decision whether to continue operating the oil refinery at the current performance level and providing, for display in the user interface, information about the decision.

A fifth feature, combinable with any of the previous or following features, where the method further includes generating, based on the information regarding operation of the oil refinery, alerts and advisories for display in the user interface.

A sixth feature, combinable with any of the previous or following features, where the proactive and reactive data include suggestions for actions to performed at the oil refinery.

In a second implementation, a non-transitory, computer-readable medium stores one or more instructions executable by a computer system to perform operations including the following. Field data for distillation column feed streams and associated processes of a crude distillation unit of an oil refinery are received. Maintenance history events and estimates per event of each distillation column of the oil refinery are received. Mass and energy balance around each distillation column are performed using the field data. Reconciled data and thermodynamic properties for each distillation column are determined using the mass and energy balance around each distillation column. Key performance indicators (KPIs) for each distillation column are determined using the reconciled data and thermodynamic properties for each distillation column and the maintenance history events and estimates per event. A decision support model for the oil refinery is executed using the distillation column performance KPIs. The decision support model models activity-based information. Information regarding operation of the oil refinery at a current performance level is determined based on executing the decision support model. Proactive and reactive data and KPIs for distillation column estimates performance of each of the distillation columns are determined based at least on the information regarding operation of the oil refinery. The proactive and reactive data and KPIs for distillation column estimates performance of each of the distillation columns are provided for display in a user interface.

The foregoing and other described implementations can each, optionally, include one or more of the following features:

A first feature, combinable with any of the following features, where the field data includes fuel gas properties and parameters, process feed parameters, and air intake parameters.

A second feature, combinable with any of the previous or following features, where the KPIs include an energy consumption per unit mass of feed though the distillation column.

A third feature, combinable with any of the previous or following features, where the operations further include performing data cleansing on the received field data and the maintenance history events and estimates per event.

A fourth feature, combinable with any of the previous or following features, where the operations further include generating a decision whether to continue operating the oil refinery at the current performance level and providing, for display in the user interface, information about the decision.

A fifth feature, combinable with any of the previous or following features, where the operations further include generating, based on the information regarding operation of the oil refinery, alerts and advisories for display in the user interface.

A sixth feature, combinable with any of the previous or following features, where the proactive and reactive data include suggestions for actions to performed at the oil refinery.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Field data for distillation column feed streams and associated processes of a crude distillation unit of an oil refinery are received. Maintenance history events and estimates per event of each distillation column of the oil refinery are received. Mass and energy balance around each distillation column are performed using the field data. Reconciled data and thermodynamic properties for each distillation column are determined using the mass and energy balance around each distillation column. Key performance indicators (KPIs) for each distillation column are determined using the reconciled data and thermodynamic properties for each distillation column and the maintenance history events and estimates per event. A decision support model for the oil refinery is executed using the distillation column performance KPIs. The decision support model models activity-based information. Information regarding operation of the oil refinery at a current performance level is determined based on executing the decision support model. Proactive and reactive data and KPIs for distillation column estimates performance of each of the distillation columns are determined based at least on the information regarding operation of the oil refinery. The proactive and reactive data and KPIs for distillation column estimates performance of each of the distillation columns are provided for display in a user interface.

The foregoing and other described implementations can each, optionally, include one or more of the following features:

A first feature, combinable with any of the following features, where the field data includes fuel gas properties and parameters, process feed parameters, and air intake parameters.

A second feature, combinable with any of the previous or following features, where the KPIs include an energy consumption per unit mass of feed though the distillation column.

A third feature, combinable with any of the previous or following features, where the operations further include performing data cleansing on the received field data and the maintenance history events and estimates per event.

A fourth feature, combinable with any of the previous or following features, where the operations further include generating a decision whether to continue operating the oil refinery at the current performance level and providing, for display in the user interface, information about the decision.

A fifth feature, combinable with any of the previous or following features, where the operations further include generating, based on the information regarding operation of the oil refinery, alerts and advisories for display in the user interface.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Particular features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in particular combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In particular circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving field data for distillation column feed streams and associated processes of a crude distillation unit of an oil refinery;
receiving maintenance history events and estimates per event of each distillation column of the oil refinery;
performing, using the field data, mass and energy balance around each distillation column;
determining, using the mass and energy balance around each distillation column, reconciled data and thermodynamic properties for each distillation column;
determining, using the reconciled data and thermodynamic properties for each distillation column and the maintenance history events and estimates per event, key performance indicators (KPIs) for each distillation column;
executing, using the distillation column performance KPIs, a decision support model for the oil refinery, wherein the decision support model models are based on activity-based information;
determining, based on executing the decision support model, information regarding operation of the oil refinery at a current performance level;
determining, based at least on the information regarding operation of the oil refinery, proactive and reactive data and KPIs for distillation column estimate performance of each of the distillation columns; and providing, for display in a user interface, proactive and reactive data and KPIs for distillation column estimate performance of each of the distillation columns.

2. The computer-implemented method of claim 1, wherein the field data includes fuel gas properties and parameters, process feed parameters, and air intake parameters.

3. The computer-implemented method of claim 1, wherein the KPIs include an energy consumption per unit mass of feed though the distillation column.

4. The computer-implemented method of claim 1, further comprising:
performing data cleansing on the received field data and the maintenance history events and estimates per event.

5. The computer-implemented method of claim 1, further comprising:
generating a decision whether to continue operating the oil refinery at the current performance level; and
providing, for display in the user interface, information about the decision.

6. The computer-implemented method of claim 1, further comprising:
generating, based on the information regarding operation of the oil refinery, alerts and advisories for display in the user interface.

7. The computer-implemented method of claim 1, wherein the proactive and reactive data include suggestions for actions to performed at the oil refinery.

8. A non-transitory, computer-readable medium storing one or more instructions executable by a computer system to perform operations comprising:
receiving field data for distillation column feed streams and associated processes of a crude distillation unit of an oil refinery;
receiving maintenance history events and estimates per event of each distillation column of the oil refinery;
performing, using the field data, mass and energy balance around each distillation column;
determining, using the mass and energy balance around each distillation column, reconciled data and thermodynamic properties for each distillation column;
determining, using the reconciled data and thermodynamic properties for each distillation column and the maintenance history events and estimates per event, key performance indicators (KPIs) for each distillation column;
executing, using the distillation column performance KPIs, a decision support model for the oil refinery, wherein the decision support model models are based on activity-based information;
determining, based on executing the decision support model, information regarding operation of the oil refinery at a current performance level;
determining, based at least on the information regarding operation of the oil refinery, proactive and reactive data and KPIs for distillation column estimate performance of each of the distillation columns; and providing, for display in a user interface, proactive and reactive data and KPIs for distillation column estimate performance of each of the distillation columns.

9. The non-transitory, computer-readable medium of claim 8, wherein the field data includes fuel gas properties and parameters, process feed parameters, and air intake parameters.

10. The non-transitory, computer-readable medium of claim 8, wherein the KPIs include an energy consumption per unit mass of feed though the distillation column.

11. The non-transitory, computer-readable medium of claim 8, the operations further comprising:
performing data cleansing on the received field data and the maintenance history events and estimates s per event.

12. The non-transitory, computer-readable medium of claim 8, the operations further comprising:
generating a decision whether to continue operating the oil refinery at the current performance level; and
providing, for display in the user interface, information about the decision.

13. The non-transitory, computer-readable medium of claim 8, the operations further comprising:
generating, based on the information regarding operation of the oil refinery, alerts and advisories for display in the user interface.

14. The non-transitory, computer-readable medium of claim 8, wherein the proactive and reactive data include suggestions for actions to performed at the oil refinery.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving field data for distillation column feed streams and associated processes of a crude distillation unit of an oil refinery;
receiving maintenance history events and estimates per event of each distillation column of the oil refinery;
performing, using the field data, mass and energy balance around each distillation column;
determining, using the mass and energy balance around each distillation column, reconciled data and thermodynamic properties for each distillation column;
determining, using the reconciled data and thermodynamic properties for each distillation column and the maintenance history events and estimates per event, key performance indicators (KPIs) for each distillation column;
executing, using the distillation column performance KPIs, a decision support model for the oil refinery, wherein the decision support model models are based on activity-based information;
determining, based on executing the decision support model, information regarding operation of the oil refinery at a current performance level;
determining, based at least on the information regarding operation of the oil refinery, proactive and reactive data and KPIs for distillation column estimate performance of each of the distillation columns; and
providing, for display in a user interface, proactive and reactive data and KPIs for distillation column estimate performance of each of the distillation columns.

16. The computer-implemented system of claim 15, wherein the field data includes fuel gas properties and parameters, process feed parameters, and air intake parameters.

17. The computer-implemented system of claim 15, wherein the KPIs include an energy consumption per unit mass of feed though the distillation column.

18. The computer-implemented system of claim 15, the operations further comprising:
performing data cleansing on the received field data and the maintenance history events and estimates per event.

19. The computer-implemented system of claim 15, the operations further comprising:
generating a decision whether to continue operating the oil refinery at the current performance level; and
providing, for display in the user interface, information about the decision.

20. The computer-implemented system of claim 15, the operations further comprising:
generating, based on the information regarding operation of the oil refinery, alerts and advisories for display in the user interface.
